(19) United States
(12) Patent Application Publication
(10) Pub. No.: US 2017/0154383 A1
(43) Pub. Date: Jun. 1, 2017

(54) Personal Disaster Insurance

(71) Applicant: Darren Wood, West Des Moines, IA (US)

(72) Inventor: Darren Wood, West Des Moines, IA (US)

(21) Appl. No.: 15/189,906

(22) Filed: Jun. 22, 2016

Related U.S. Application Data
(60) Provisional application No. 62/182,962, filed on Jun. 22, 2015.

(51) Int. Cl. G06Q 40/08

(52) U.S. Cl. CPC G06Q 40/08

(57) ABSTRACT

The process disclosed herein provides methods for the provision of Personal Disaster Insurance (PDI) which allow an insured to obtain unique protections against the event of an untoward event such as a natural disaster and, further, provides claim processes which are accomplished by use of the insured's cellular telephone. PDI products covered by various embodiments of this invention provide property and collateral damage coverage designed to make the consumer whole in a manner not currently available to consumers, which is based on unique risk management oversight of a defined geographic area. The insurance is payable upon claims verification based upon the impact to the insured resulting from a natural disaster or “trigger” event occurring at the policyholder's home of record, or other covered location. The coverage provides a lump sum cash benefit of the full policy coverage amount or other appropriate benefit to policyholders impacted by natural disasters or other named events that dramatically impact the daily life of an insured. Covered disasters may include, but are not limited to: hurricane, tornado, tsunami, earthquake, blizzard, prolonged power outage, terrorist attack, and major flooding.

This application is based upon U.S. Provisional Application Ser. No. 62/182,962 filed Jun. 22, 2015, the complete disclosure of which is hereby expressly incorporated by this reference.

### BACKGROUND

Wider variation in natural occurrences, particularly related to weather events, is on the increase. This operates to present greater opportunity for occurrences which damage one's belongings and home and, further, said damage is greater than historically has occurred in the past. As a result, there is an increasing need to protect individual and corporate property and possessions from these occurrences. When such personal catastrophes resulting from natural occurrences happen, there is an immediate need for the insuring entity to respond, fairly evaluate the loss, and make immediate payment to the insured to facilitate resumption of normalcy. That is not possible with the current offering of insurance products on the market. The lack of a comprehensive policy leaves a glaring need for a policy that covers catastrophic events (perils) that makes the consumer whole, post disaster, by providing coverage for the primary damage and additionally covering collateral loss exposures. Additionally, these natural occurrences may occur anywhere, and in isolation, present a formidable challenge to underwrite, but when managed within a larger systemic program, immediate adjustments in the acceptance of additional risks and the pricing of risks may be accomplished. Heretofore, there was not a comprehensive, systematic approach either in the offering of appropriate casualty/property insurance coverages, the management of risks associated with these insurance coverages, or the dynamic underwriting approach which provides the foundation for the systematic approach.

### SUMMARY OF INVENTION

Personal Disaster Insurance Coverage (PDI) systems and methods as disclosed herein may operate either as an endorsement to a homeowner's insurance product, commercial disaster insurance products, or as a stand-alone personal line of property/casualty insurance products. The PDI products provide property and collateral damage coverage designed to make the consumer whole in a manner not currently available to consumers, which is based on unique risk management oversight of a defined geographic area. The insurance is payable upon claims verification based upon the impact to the insured resulting from a natural disaster or “trigger” event occurring at the policyholder's home of record, or other covered location.

The various embodiments of this invention provide comprehensive protection options to the individual and corporation where heretofore comprehensive protection was not made available. In states impacted by a major disaster, bankruptcies increase by 50% in the 3 years immediately following a disaster. This invention is designed, in part, to provide needed assistance to those who otherwise would be financially devastated by a major disaster.

The coverage provides a lump sum cash benefit of the full policy coverage amount or other appropriate benefit to policyholders impacted by natural disasters or other named perils or events that dramatically impact the daily life of an insured. Covered disasters may include, but are not limited to: hurricane, tornado, tsunami, earthquake, winter storm, prolonged power outage, terrorist attack, flooding, wild fires, typhoons, sink holes, and land/mud slide events.

### BRIEF DESCRIPTION OF DRAWINGS

FIG. 1 is an exemplary method for provision of Personal Disaster Insurance.

FIG. 2 is an exemplary method of distribution risk management related to the provision of Personal Disaster Insurance.

FIG. 3 is an exemplary method of automated maintenance processes applicable to Personal Disaster Insurance policies.

FIG. 4 is an exemplary method of notification and advance preparedness related to the provision of Personal Disaster Insurance.

FIG. 5 is an exemplary method for claims process initiation related to Personal Disaster Insurance.

FIG. 6 is an exemplary method of claim verification, evaluation and determination related to Personal Disaster Insurance.

FIG. 7 is a further exemplary method of claim verification, evaluation and determination related to Personal Disaster Insurance.

FIG. 8 is an exemplary method of claim submission utilizing a cellular telephone or other personal digital assistant related to Personal Disaster Insurance.

FIG. 9 is an exemplary method of claim verification and processing related to Personal Disaster Insurance which process is assisted by use of the insured's cellular telephone or other personal digital assistant.

FIG. 10 is an exemplary method of claim verification and processing related to extended loss of power claims under the Personal Disaster Insurance which process is assisted by use of the insured's cellular telephone or other personal digital assistant.

FIG. 11 is an exemplary method of claim verification and processing related to other endorsement claims under the Personal Disaster Insurance which process is assisted by use of the insured's cellular telephone or other personal digital assistant.

FIG. 12 is an exemplary method of claim attestation under the Personal Disaster Insurance which process is assisted by use of the insured's cellular telephone or other personal digital assistant.

FIG. 13 is an exemplary overview process related to Personal Disaster Insurance.

### DETAILED DESCRIPTION

The invention covers multiple embodiments which include multiple coverage options and the systems and underwriting processes, all of which make the invention unique and functional. Certain embodiments of the invention disclosed herein represent a unique approach and method to providing insurance coverage that heretofore were not available, particularly in a comprehensive multi-peril package. Various embodiments of the invention include use of a base insurance package. One base insurance package provides for a lump-sum cash payment in the event of an insured loss. This coverage is for losses to the insured's property, real and personal, located within a natural disaster area as officially declared by either state or federal officials. The package further provides coverage for personal property loss. In a preferred embodiment the PDI coverage is specific only to disaster related events, and the protection is designed for the purpose of covering collateral damages not covered by other insurance and, also, primary damage to the insured property and other belongings, from perils frequently excluded from standard property policies. If associated with an underlying property casualty or other insurance policy, submission and/or approval of a claim on an underlying policy to trigger PDI claim payment is not required which operates to prevent long waits by the insured in the event of a major catastrophe. Premium calculation is based actuarially on the geographical propensity for a claim to occur at the geographic location of the insured property, and is not based on a proportion of another policy's premium.

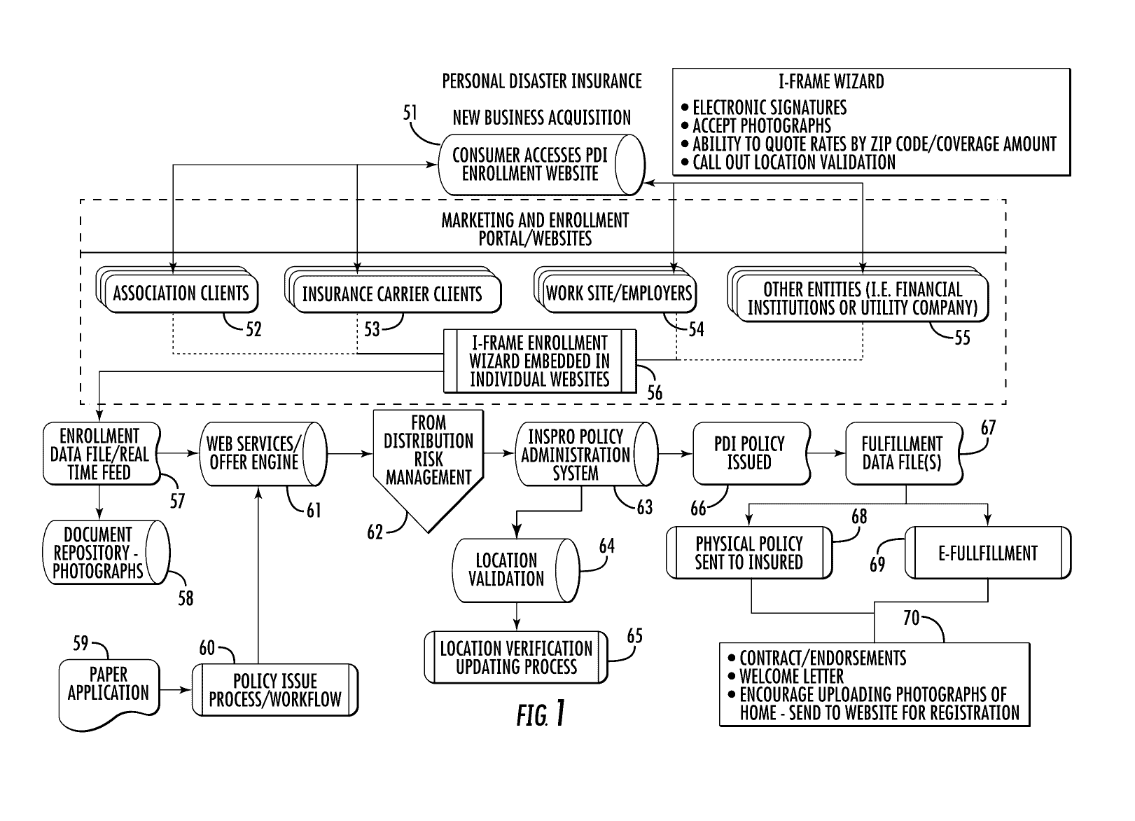

FIG. 1 illustrates a commonly used method by which a consumer (51) will enroll for coverage through various industry distribution partners' websites (52, 53, 54, 55) utilizing an enrollment wizard (56). In one embodiment, the enrollment wizard, in real time, passes customer inputted data, including the requested coverage amount, to the web services/offer engine (61). This generates a rate based on the coverage amount selected, the damage threshold selected, and the geographic location of the consumer. The web services/offer engine (61) then cross-references whether new enrollments are allowed in the consumer's geographic region based on the distribution risk management process (62).

If new policies are allowed, the policy administration system (63) verifies the consumer residence is a valid address (64 &65) and issues a PDI policy. The insured (51) is sent policy information (18 &19) consisting of the insurance contract, welcome letter and is provided a link to establish an online “my account” through which they can upload pictures of their home (70).

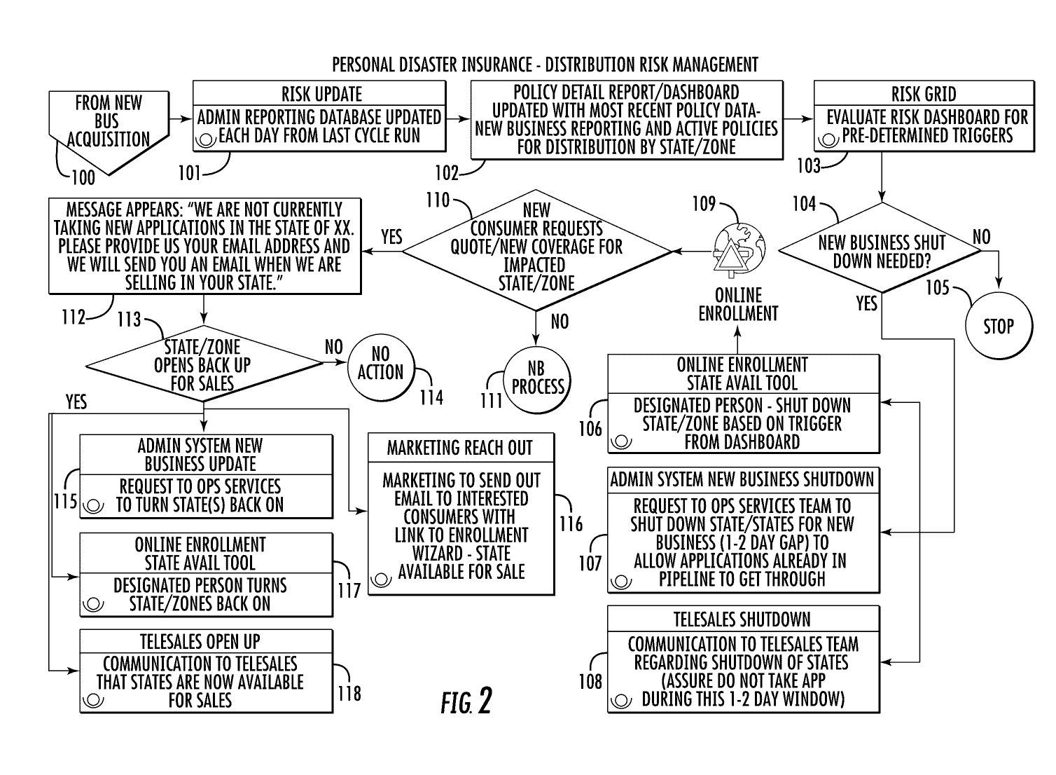

FIG. 2 illustrates an embodied method of risk management which may be employed with the PDI insurance. In one embodiment, this method operates to stop new customer enrollments if pre-established proportions of existing policies in medium or high risk geographic areas are too high compared to the number of policies in lower risk geographic areas. In this embodiment a key aspect of the PDI insurance product is to balance the risk across low, medium, and high risk areas. This ensures that individuals in medium and high risk areas will be able to afford at least some coverage to protect their families. For example, it is understood that with this embodiment, a $5,000 policy for someone in Florida would issue at a premium of $360, while without this method the premium to be charged would be on the order of $2,000. This operates as an important feature in this embodiment exemplar since more than 50% of the U.S. population live within 100 miles of the coast. Further, this feature is made more important by the fact that 25% of all U.S. households have no savings, and the overall average savings in the U.S. is $3,800. As such, even moderate damage from a disaster can spell financial ruin for the average family.

The embodied method in FIG. 2 further illustrates the use of a continuous and up-to-date risk analysis and management process. In one embodiment, the process begins with the reports being generated nightly (101) which depict the risk distribution of policies across risk areas (102). Reporting is analyzed (102/104) and if within allowable thresholds, new applications will continue to be processed (105). If the risk ratios are out of tolerance, the online enrollment engine (106) will be disabled for medium and high risk geographic areas. Additionally, processors handling paper enrollments (107) and telesales will stop processing applications in medium and high risk areas. Consumers attempting to enroll in the medium and high risk areas will receive a message advising that we are temporarily not taking new applications (112). They are prompted to provide their email address and will receive a notice when enrollments resume (116). Further in this embodiment the risk ratios are re-evaluated nightly and, if within allowable thresholds, will reopen (113) enrollment ability for those in medium and high risk zones. This risk manage approach will be augmented by frequent marketing efforts to generate customers in lower risk geographic areas. This approach will create a buffer in the risk ratios to minimize the risk shutdown periods.

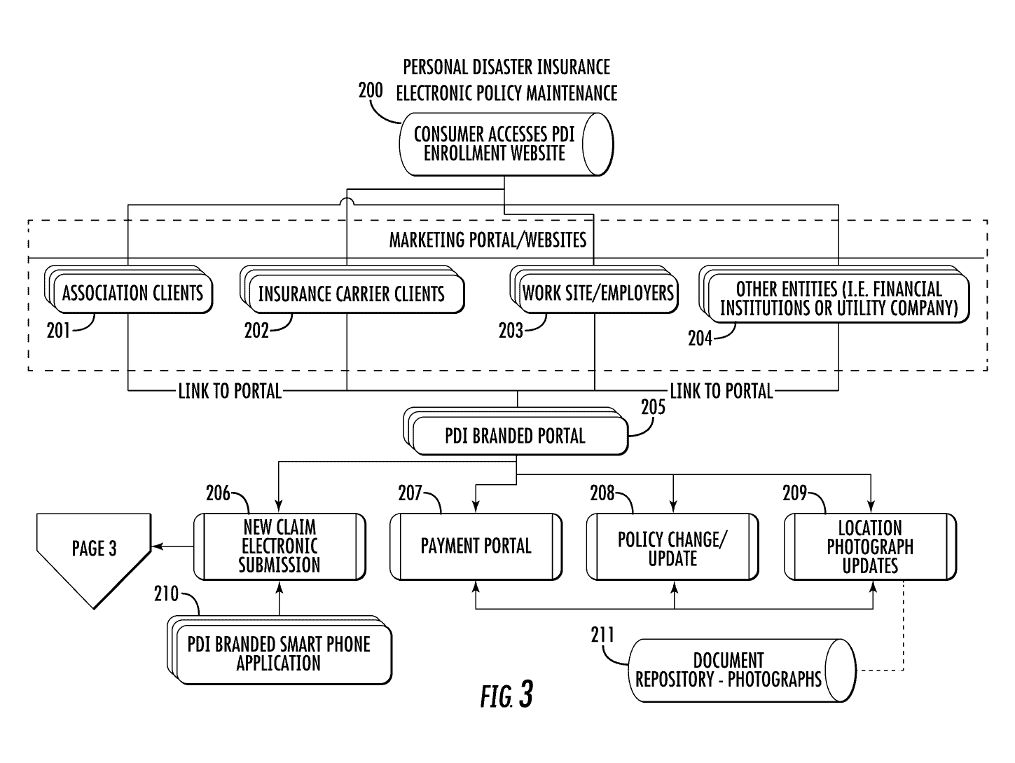

FIG. 3 illustrates a method of electronic policy maintenance. In the embodied method disclosed in FIG. 3, customers may make payments, change coverage features, and other common activities. The process depicted in FIG. 3 is known to the insurance industry.

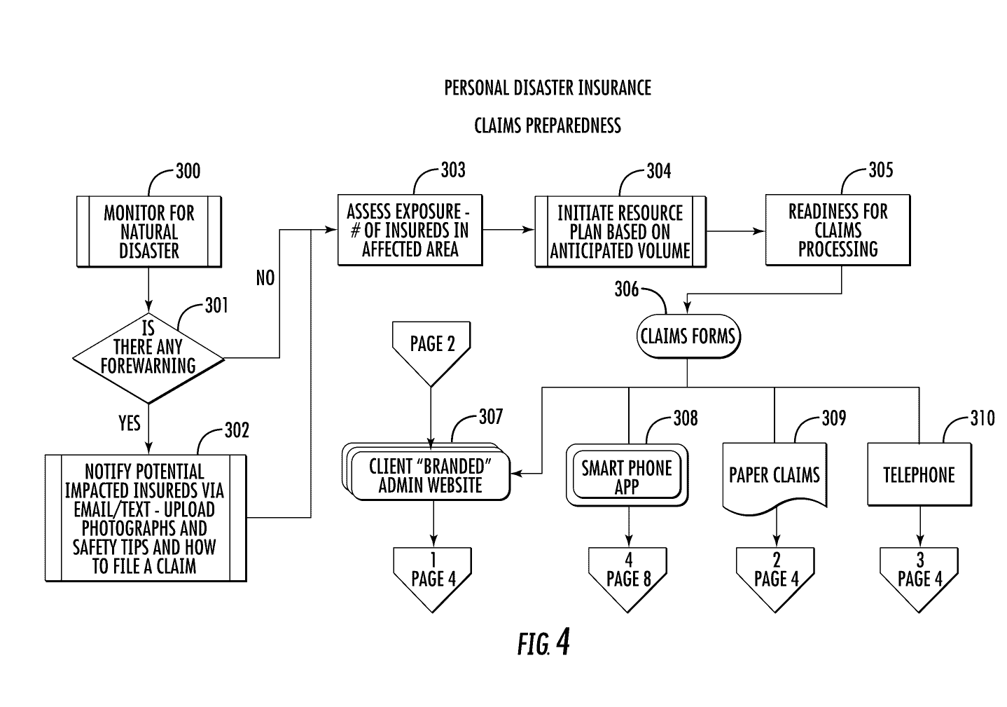

FIG. 4 illustrates a method of communication and claim preparedness. In the illustrated embodiment, continuous monitoring for disaster causing perils (300) occurs daily and includes monitoring for hurricanes, and wildfires, for example. If advance warning is available (301) a notification via email or an alert through the PDI web app (Android or IOS) will occur (302). This notice will provide peril specific safety and preparedness information in addition to prompting the customer to make sure the pictures of their home are updated in case they incur damage. Additional monitoring occurs such as determining the number of policy holders in the danger area (303). If a major disaster is imminent, additional resources can be engaged (304) to ensure optimal service delivery to insureds impacted by the disaster. If a customer incurs damage they can initiate a claim via the web, PDI app, mailing in a claim form, or via the telephone (307, 308, 309, 310).

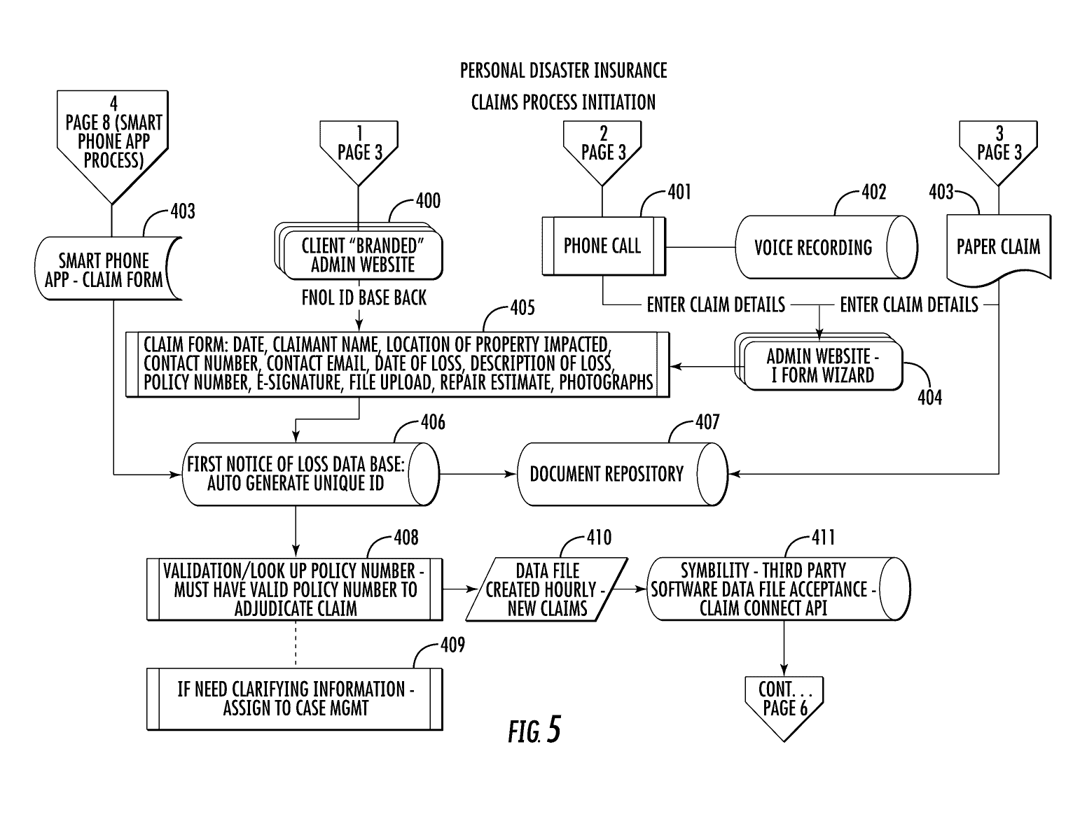

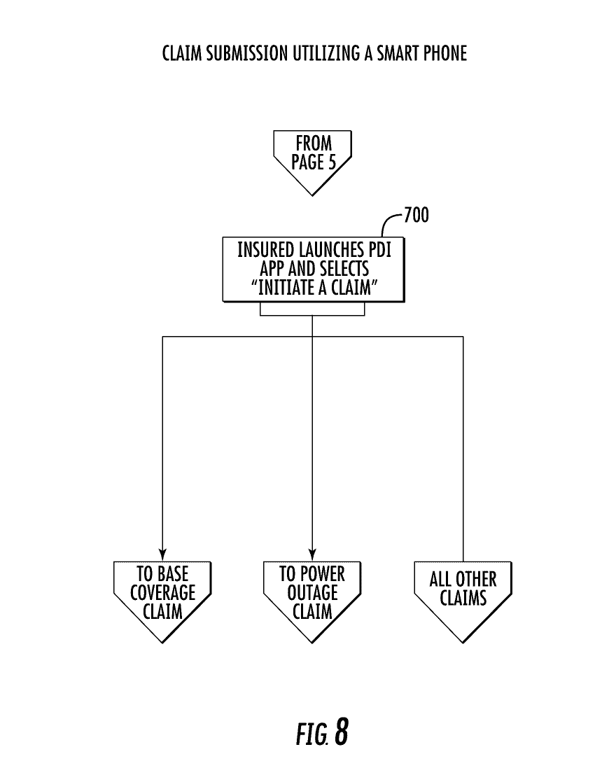

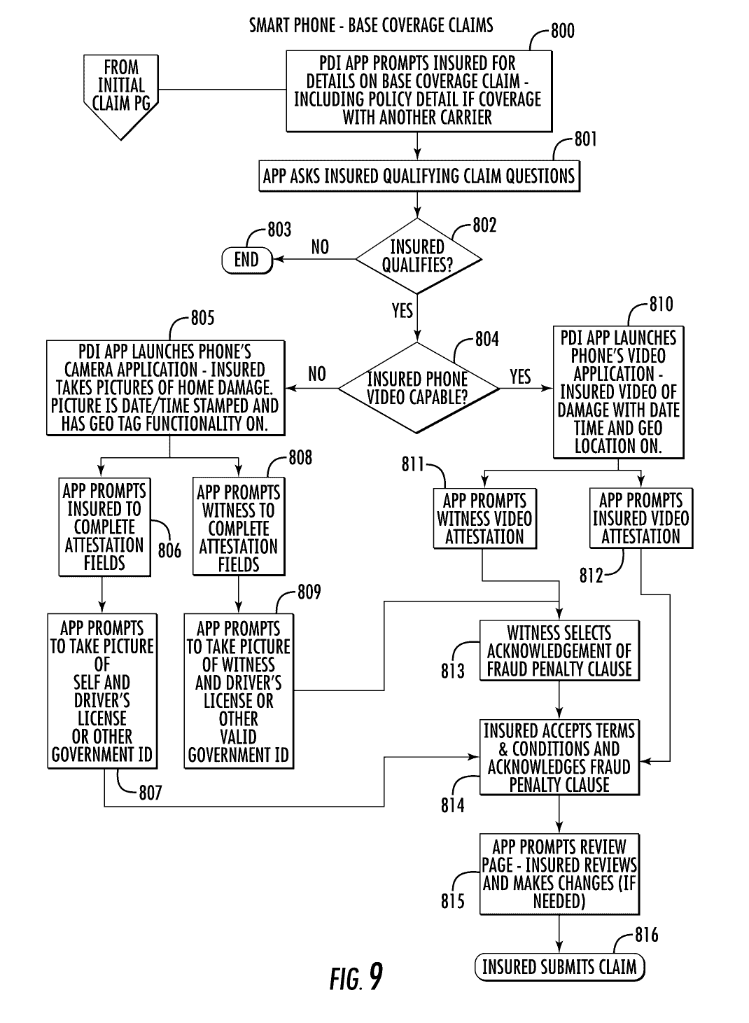

FIG. 5 illustrates a claim initiation process under the PDI policy. In one embodiment, the insured is able to use an app for ease and speed of claims submission. This process is shown in greater detail FIGS. 8 and 9.

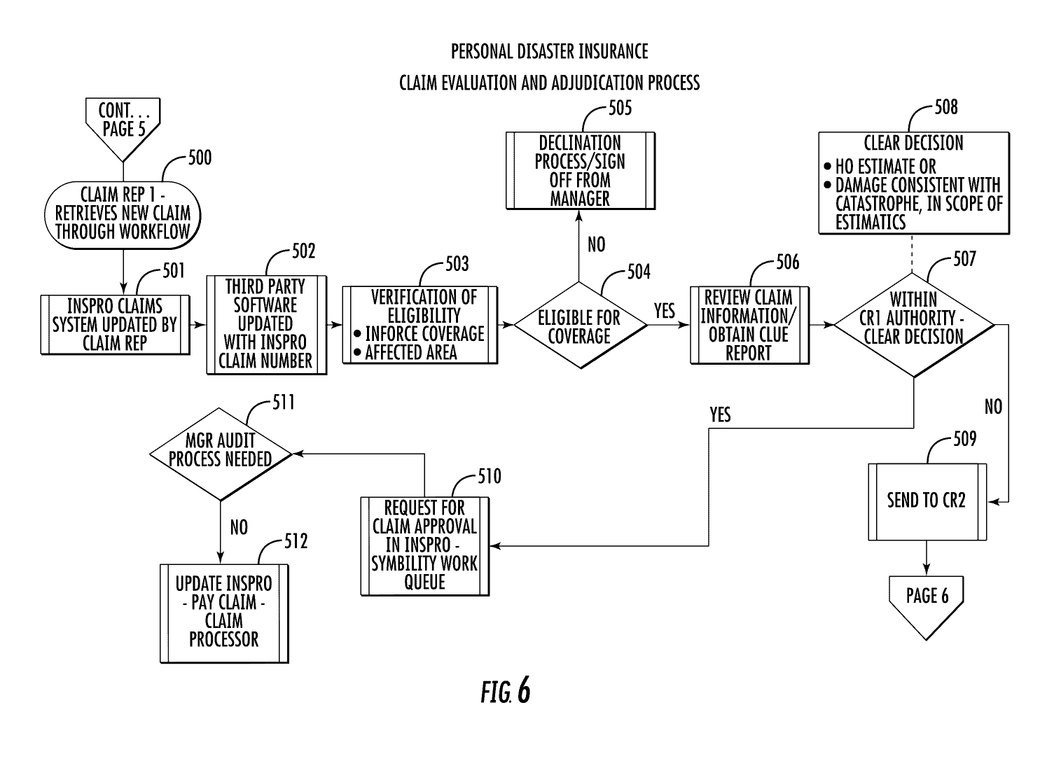

FIG. 6 illustrates a method by which claim evaluation and determination are made by the insurer. In this embodiment, the process begins with the receipt of a claim from the insured (500). The claim is inputted into the claim system (501) and assigned a claim number (502). The claim representative 1 (CR1), an entry level processor then validates an active policy, a disaster declaration that encompasses the insured's residence (503 &504). If those criteria are not met the claim goes to a claim manager for declination (505). If those conditions are met the claim rep accesses the CLUE database (506), an industry claim repository to determine if a claim has been filed on their home or renters policy for this disaster. A feature contributing to the efficiency of the PDI claim process is clear cut approval authority for the CR1 and claim representative 2 (CR2). The CR1 is given a list of severe damage items that will always surpass the established damage threshold. For example, the CR1 list may include the following items: the home is completely destroyed; the roof of the home is gone; an exterior wall or walls or the home are displaced or missing; a tree fell on the structure; a structure showing existing flooding of the home and surrounding area. These are common examples and allow the CR1 to quickly approve a claim in less than 2 minutes (507 & 508). The claim is then routed in the claim system (510) for manager approval (511). Once approved, the claim goes for payment to the insured (512). Target claim processing is 24-48 hours on 99% of claims due to this efficient system. If the claim damage does not fall into one of the CR1's approval areas it is routed to a CR2 (509).

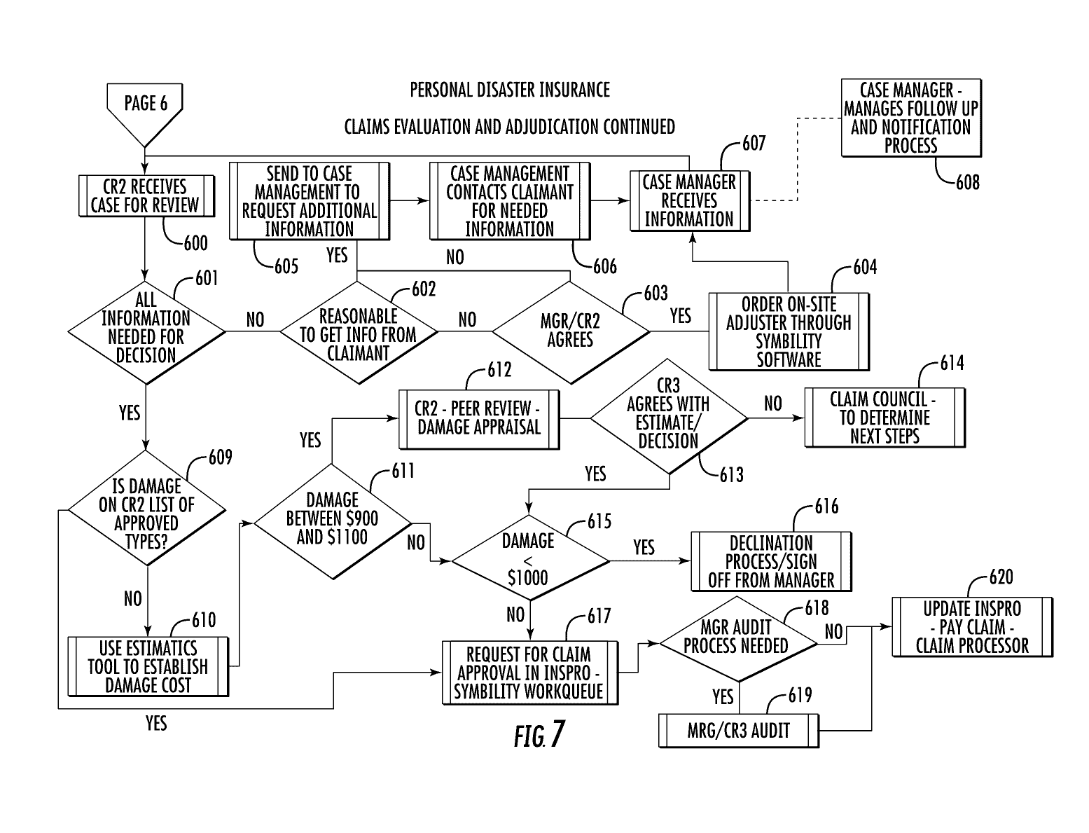

FIG. 7 illustrates a continuation of the claims evaluation and adjudication process. In this embodiment the claims representative 2 (CR2) is an experienced claims professional. The CR2 has a listing of 10-15 predefined damage types (similar to the CR1 in FIG. 6) that allow them to automatically approve. Once the CR2 receives the case for review (600) they determine if they have all information required to make a decision (601). If all required information is not presented or otherwise available with claim submission, the case is routed to case management to contact the insured and work with them to gather the needed information (605, 606, 607, 608). In this process, the case manager or other personnel of the carrier determine if they can reasonably gather the information from the insured (602). If necessary information is not reasonably available from the insured and the manager agrees (603), an onsite adjuster may be retained via use of the claim software package (604). If the CR2 has the required information and the damage type is on the CR2 list of approved types (609) the CR2 approves and is routed to the approval queue (617). The claim manager audits random cases and signs off as needed (618). The claim then is routed for payment (620). If the damage is not on the CR2s approval list they estimate damage using claim pictures or video claim tools (610). If the damage is within 10% of the damage threshold (611) it goes to a peer CR2 for review (612). If the peer CR2 agrees and the damage is over the threshold, it goes through the approval process for payment (617-620). If the damage is less than the threshold it goes to the manager for declination (616).

FIG. 8 illustrates is an embodied method of a claim submission utilizing a smart phone and the PDI App. If the insured uses the PDI App and elects to file a claim (700) they are prompted to choose the claim area and are routed to that area to complete the process.

FIG. 9 further illustrates an embodied method of claims submission utilizing a smart phone and the PDI App to file a claim for the base PDI coverage. If the insured selects base coverage claim (800), they are asked claim questions to determine if damage is from the disaster and if they are in a state or federally declared disaster area (801). If the qualifying criteria are not met, the insured is informed with the reasoning explained (803). If the criteria are met the app determines if their phone has video capabilities (804). If so, the PDI app launches the phones video application to take a video of the damage, with a date/time stamp and geo location tag activated (810). Once complete the phone prompts the insured to attest to the legitimacy of the damage (812). The app also prompts for a witness to attest to the legitimacy of the damage via video (811). The witness must also acknowledge they understand the penalties of a fraudulent attestation (813). The insured is then prompted to accept the terms and conditions and fraud attestation (814). The insured is then allowed to review the claim and make any final changes (815). Once complete the insured submits the claim (816).

If the insured does not have video capabilities (804) the PDI app launches the phone's camera and turns of the geo tag to tie the pictures to the insureds residence location in an effort to prevent fraud (805). The PDI add then prompts the insured to complete attestation fields within the app (806) and prompts them to take pictures of themselves and of their driver's license or government issued identification (807). The PDI app also prompts a witness to attest to the damage (808) and has them take a picture of themselves with their driver's license or government issued identification (809). Both the witness and insured acknowledge fraud penalties (813/814). The insured can then review (815) and submit the claim 816).

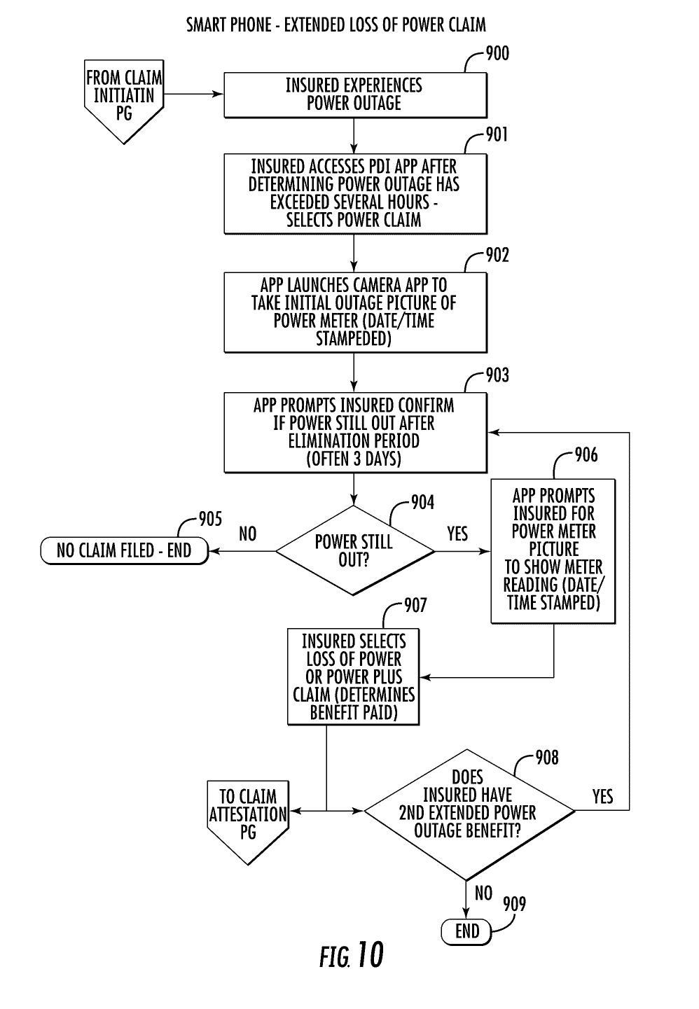

FIG. 10 illustrates an embodied process relating to an extended loss of power, and the processes related to claim submission by the insured via use of an app. Once the power goes out for several hours the insured (900) can launch the PDI app and select loss of power claim (901). This launches the camera on the phone with the date/time stamp and geo location tag (902). Once the insured takes a picture of the power meter, the app automatically prompts the insured after the required elimination period (often 3 days) and asks if power is still out (904). If no, no claim is filed and the process ends. If yes, the app prompts the insured to take a picture of the power meter with the date/time stamp and the geo location tag (906). The insured selects the loss of power claim which routes the insured to the attestation portion of the PDI app in FIG. 8 steps 804-816.

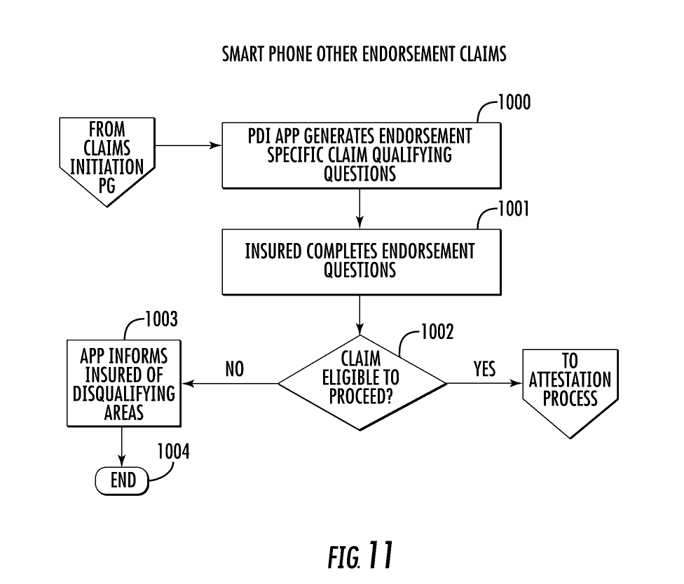

FIG. 11 illustrates additional embodied methods related to PDI coverage provided to the insured. Such covered events trigger the PDI app to generate endorsement specific questions (moo). The insured answers the questions within the PDI app (low) and is advised based on their responses whether they are eligible to file a claim 1002). If not (1003) they are informed why their situation does not qualify. If they can file a claim they are routed to the attestation process in FIG. 8 steps 804-816.

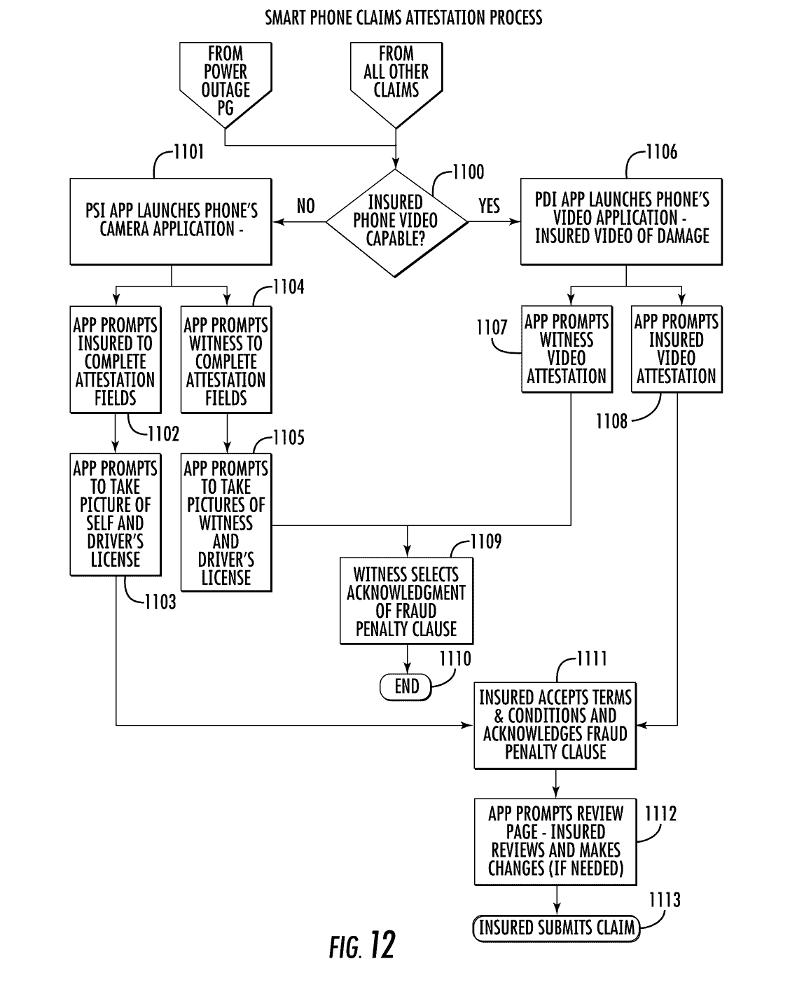

FIG. 12 further illustrates an embodied method of claims verification and attestation utilizing a smart phone and the PDI App. In this embodied method, the insured utilized the camera in the cellular telephone or other personal digital assistant provide claim verification data and, further, to provide the required attestation in order to obtain claim approval and subsequent payment.

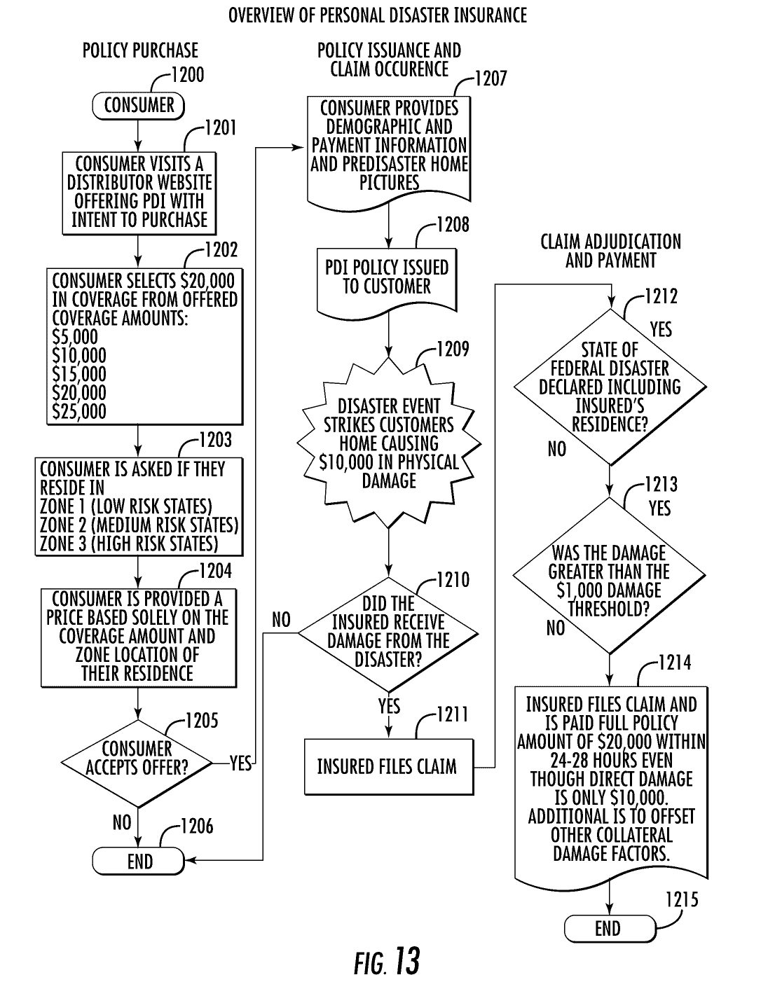

FIG. 13 provides an overview of the method associated with the acquisition, issuance, claim submission and claim determination processes associated with Personal Disaster Insurance.

In differing embodiments, the inventive PDI coverage will offer individual and group rate options with group rates being discounted.

In differing embodiments, the inventive PDI coverage requires the state or federal government to declare a disaster encompassing the insured's location, and that the primary or real cause of the damage must be from the declared disaster peril.

In differing embodiments, the PDI coverage and methods of administration include the provision of various non-insurance goods and personal property, and the provision of various assistance and other services to the insured; all designed to deliver a holistic solution to insureds who have incurred the travails of a disaster.

In differing embodiments, the invention would pay a lump-sum coverage amount equal to 100% of the elected coverage amount to the insured if their primary residence has damage greater than the set damage threshold or self-retention amount if the damage is directly caused by a covered natural disaster event or other insured peril and the insured's real property is in a state or federally declared disaster area.

In differing embodiments, the invention provides a cash value account or other cash reserve acting as an emergency fund to the insured. One method to fund this cash reserve account would be as an addition to the annual premium. Another method to fund the cash reserve account would be to provide it as an optional feature, and to charge the insured a specific premium amount for a preset cash benefit amount.

In another embodiment the package provides for coverage is electable at different face amounts. One preferred embodiment provides a micro-PDI form of coverage with loss coverage ranging from $1 up to $1,000 per occurrence. Another embodiment of the invention utilizes a preferable range providing coverage of $5,000 up to $25,000 per occurrence. Other preferred embodiments for commercial property or higher net-worth insureds, provides coverage well in excess of $25,000.

A preferred increment between coverage amounts is $5,000, but other suitable increments are in the range of $500 to $10,000. The insurance carrier offering this product has the option to offer the product at a set rate per $5,000 of coverage regardless of geographic area or to base rates on the frequency of claim events or magnitude of claim events within a given geographic area. The writing carrier(s) can opt for the model that best suits their revenue and risk goals. Carriers may also elect to provide a reduced benefit if the damage caused to the insured's primary home is less than a certain threshold. For example, if the insured's home receives only $1,000 (and the threshold is $2,000 for $10,000 in coverage) in damage, the benefit payable to the insured would be reduced by a stated percentage (e.g. 50%). An alternative embodiment is the use of an initial threshold loss amount or, alternatively, a self-retained loss amount, which provides that any loss above the threshold or deductible amount results in payment of the entire coverage benefit regardless of the total loss incurred by the insured.

Further features contained within the various embodiments of this invention include a variety of coverage endorsements. Any combination of these features may be offered as a part of the base coverage or as optional endorsements. Further, the insurance carrier may require additional premiums for these endorsements based upon a variety of reasons including marketing and underwriting considerations.

One of the coverage option features available under implementation of this invention pays a reduced face amount if they are impacted by a mandatory evacuation order given by governmental authority that impacts their home of record due to a disaster event. The evacuation coverage requires the insured be displaced from their home of record for a minimum number of days.

Another coverage option feature provides for coverage in the event of an extended loss of power to the insured dwelling or other insured real property. Optionally, this endorsement may provide differing coverage amounts and be utilized to pay a power loss claim without an event triggering payment of the entire policy face amount (e.g. if not underlying homeowner's claim). This endorsement can have differing payout thresholds. For example, it may provide a stated, limited benefit amount based upon a stated event or stated period of time related to the power outage, and should the power outage continue past threshold period, provide a differing benefit payment to the insured.

Another coverage option feature that may be included within this invention is the provision of temporary relocation and disaster relief services. This disaster concierge service may include use of a call center for ease of access by the insured. One method of administering this feature would be to provide the service for a stated number of hours' worth of time. Upon usage of the stated hours, the insured may be provided with an option to purchase additional time/support from the concierge service provider. This service may include the provision of a variety of services which may include facilitation in finding temporary housing, disaster clean-up, reconstruction, and coordination and facilitation for other ordinary living needs of the insured. Examples of the specific services which may be included under this feature are locating and booking guaranteed hotel reservations, locating or arranging longer term living arrangements (often until the insured can return to their home), provision of liaison services with insurance carriers to facilitate communication and claims processing, coordination of contractors or other entities providing services to the insured that resulted from the disaster, and supply ordering and coordination of delivery to the insured.

Another coverage feature option included within various embodiments of this invention is a safe senior endorsement. This endorsement provides that in the event of a triggering natural disaster, a safety check to the insured or a named senior, mostly likely a parent, of the insured. The benefit provides safety check services to one location. Services may include a contact service whereby contact to the senior to check on their status is made on a recurrent and regular basis. Such service may further provide that if the contact resulted in a determination that the senior was safe, the carrier contacts a party designated by the insured to make the status report. If the determination upon contact is that the senior is not safe and does not require medical assistance, the carrier will facilitate transportation of the individual to an evacuation center or shelter being utilized by governmental authorities or to private accommodations depending upon the nature of the coverage provided in the endorsement. If the senior is not safe and requires medical assistance, the carrier will coordinate with a medical provider to bring the named senior to a medical facility. If no contact is made with the named senior within the predetermined reply time frame, a person will physically go to the named senior's physical address to determine the status of the senior.

Another coverage option feature that may be included within this invention is the provision of an emergency supply kits to insured. Various options may be provided the insured as to the number of kits and the kit size and quantity of goods. Such kits may provide food, water, personal hygiene items, cooking stoves with propane canisters, emergency radios, flashlights, batteries, disposable cellular telephones, universal solar cell phone chargers, and other necessities to insured The carrier may also provide the opportunity for an insured that did not elect the endorsement prior to a disaster event to order kits post-disaster from their supplier at a discounted rate. This benefit can generate significant goodwill in the community.

Another coverage option feature that may be included within this invention is the provision of an endorsement providing emergency power equipment which may include one or more of a gas powered generator, heating and cooling fans, and additional items such as gasoline and extension cords.

Another coverage option feature that may be included within this invention is the provision of emergency pharmaceutical services. This benefit facilitates the emergency refill of prescriptions to policyholders that have an active prescription. Benefit features may include the carrier providing the location of the nearest functioning pharmacy through which the insured may have their prescription filed, or the carrier making all necessary contacts to the pharmacy to facilitate the preparation and delivery of the prescription.

Another coverage option feature that may be included within this invention is the provision of vacation home coverage.

Another coverage option feature that may be included within this invention is the provision of lost job coverage related to the insured's employer going out of business as a result of a natural disaster.

Another coverage option feature that may be included within this invention is the provision of an endorsement for hazmat contamination. In the event that the insured is forced to evacuate due to Hazmat contamination, a stated benefit amount would be paid, preferably subject to a waiting or elimination period of short duration. This coverage option preferably would not require an underlying homeowner's claim event caused by a natural or other disaster.

Another coverage option feature that may be included within this invention is the provision of a quarantine endorsement. Such coverage would preferably provide for immediate payment should the insured be forced to leave the covered premises and could be limited or capped by the number of displacement days covered or a specific dollar amount.

Another coverage option feature that may be included within this invention is the provision of pet care coverage. Such endorsement would preferably provide the benefit for up to 30 days covering pet boarding in disaster event. Preferably, the insured would have the option of selecting basic boarding coverage with a dollar amount cap or enhanced coverage which delivers a benefit of higher per day value. Further preferably, the insured would have the ability to purchase coverage for multiple pets.

Within this invention an insurance carrier is preferably provided with multiple distribution options for delivery of Personal Disaster Insurance to the marketplace, and a non-limiting listing is hereinafter discussed. Personal lines insurance products like homeowner's coverage may include such disaster coverage as either an integral part of the policy or as an optional endorsement. Stand-alone PDI may be offered through banks or other financial institutions, usually as a part of the home loan or other financial programs offerings of the institutions. Such coverage may be offered through employers or employment benefit carriers and providers as a benefit option to employees. Such coverage may be offered either as a part of benefits associated with the ownership and use of a credit card and related service, or as a separate product offering made by the credit card company to its customers. This coverage may be offered as a benefit or as a direct product offering to its members by associations. Preferably, several of the entities listed above could make such offering either as a paid benefit associated with membership or participation, or at a reduced rate.

This invention preferably provides for the provision of the coverage following generally accepted insurance practices. Policyholders will receive a summary of coverage page and, in the case of a stand-alone policy, a copy of the policy documentation. An additional policy issuance enhancement can include, at the carrier's discretion, the option of issuing a Personal Disaster Insurance branded debit card with a zero balance in the insured's name. In the event of a validated claim, the debit card would be funded by the carrier with the policy proceeds. This will greatly benefit the insured at the time of a covered event.

The invention disclosed herein preferably contemplates the use of customary insurance practices for each carrier offering the coverage.

The invention provides for the use of customary insurance practices in processing claims by insureds. As a part of the coverage contemplated by this invention, it is preferable that insurance carriers have the ability to offer simple triggering events and a simplified claim submission process given that such claims will be submitted by insureds under the stress and trauma of disaster events. Generally, the preferred process would include that a claim must either satisfy the policy claim requirements for the base policy coverage or the endorsement coverage criteria. Submission of a claim may require completion of a claim affidavit. Such claims practices may preferably allow for the insured to submit a claim via email with photographs taken by the insured's cellular telephone serving as a sufficient basis for the initial payment of benefits. Such claim practice may be followed by more rigorous submissions and analysis depending upon the nature of the disaster event and the desires of the insurance carrier as expressed in the policy of insurance or other disclosure documents.

As a part of the functioning of this invention, insurance carriers may optionally require its insureds to provide annual photographic references of the real and personal property covered by the insurance coverage, and to work cooperatively with its insureds to guarantee that such continuum of photographic evidence is provided and retained for each insured.

A preferable feature of this invention where the insured has pharmacy coverage, is the use of an app or web site to prompt the insured to input prescriptions details, pharmacy details, writing doctor, and other details into system for use in case of a claim.

Preferably, the claims submission process will employ an App and website having claim affidavit capabilities, thus providing the insured with the ability to submit claim affidavit electronically during a disaster. The base claims process would preferably establish criteria related to defining a valid and confirmable loss such as actual physical damage to the insured real and/or personal property, same occurring within a governmentally declared disaster area.

The claim verification process would preferably involve a review of the insured's submission including the affidavit detailing the loss as well as a review of the photographic submissions of the insured. Claims approval would preferably be based upon the insured's submission so as to facilitate the speed of claim resolution and payment to the insured, but actual inspection by insurance company personnel or third-party personnel based upon established verification criteria including information obtained via review of the Comprehensive Loss Underwriting Exchange (CLUE) database.

Preferably, a coverage the requirements for the invention includes provision of ease of claim payment to the insured. Preferably, the procedure would include payment of the approved claim dollar amount funded to Personal Disaster Insurance debit card, unless an alternative means is requested by the insured, with such finding occurring on a daily basis. An alternative preferred process would involve the direct deposited into the insured's bank account upon request or a paper check sent.

The invention also contemplates denial of claims and methods for resolving such issues. It is preferred that a telephonic resolution process is employed so as to expedite the resolution process in light of the speed of determination preferred with the implementation and practice of this invention.

This invention also preferably employs the creation of a web or mobile app (Apple iOS or Android) to support the product. This App would preferably contain the claim affidavit and utilize an e-signature approach and, also, provide for pictures of the incident to be taken and attached to the claim submission and the use of video from the insured as an attesting party in further support of the claim.

The invention preferably utilizes an actuarial analysis of the expected rates of claim submissions and forecasted claim amounts in fixing pricing, which structures may include flat rate pricing, which may be constructed based upon the coverage amount elected versus loss history within the geographic area wherein the insured premises is located. Preferably, such pricing structure would allow for pricing in lower risk areas to allow for an offset of the higher premium associated with geographical risk based rating. The preferred approach being to keep pricing as affordable as possible in areas where there is likely to be higher product demand. Alternatively, a risk based structure may be employed which is tied to actual loss profiles with rates lower in low risk areas and higher in areas with higher frequency of trigger events.

Another preferred method is to group the zones or regions across the United States that have similar loss experience or are categorized with similar risk thresholds for purposes of establishing pricing for the PDI coverage. One method of pricing is to establish a flat rate based upon actuarial analysis, or another method would employ the identification and assigned valuation of specific risk factors present within each zone or region, with variable rate structures adopted based upon the collective risk factors impact.

Another preferred method of pricing would employ nationwide risk assessment and pricing. This embodiment spreads the risk to a larger number of insureds with a corresponding offset of costs.

It is preferred that the PDI coverage product employ a zone balancing approach. To ensure long-term viability of the PDI product, it is beneficial to maintain a balance of policies throughout the geographic areas. This balance employs a melding of higher risk and lower risk policies. Such balance is preferably achieved by establishing a ratio of low, medium and high risk policies. Such risk factors are preferably classified by zone, so that, for example, all policies placed with insureds within zone 3 would represent high risk policies in the overall balance approach. In its preferred application, the invention would call for a ratio of 4 low risk to 2 medium risk to 1 high risk policy. On a nightly basis, the computer program would analyze the policy mix across all zones which information would thereafter be exported to the enrollment segment of the inventive system. If an improper ratio of policy mix is determined to exist, the system would restrict the acceptance of new higher risk policies until the proper balance is restored, and would automatically communicate this action to the prospective insured, preferably via email. Once restoration is attained, the system will automatically contact the prospective insured to advise that enrollment is reopened and to immediately contact the carrier to enroll if the PDI coverage is still desired by the prospective insured.

The following prophetic example illustrates how the primary method of administration of the invention operates with the insured. The insured lives in Florida and have purchased a $25,000 PDI policy. A hurricane strikes the insured's home with storm surge causing $15,000 of direct damage to the home. The customer's home insurance carrier will not cover the event due to the “wind vs water” restrictions so common today in property casualty policies. The insured files a PDI claim and because they surpass the required damage threshold, are in a federal disaster declaration area they receive the full $25,000 coverage amount even though direct damage is only $15,000. The additional monies are designed to offset the other collateral damage aspects facing the consumer.

The following prophetic example illustrates another aspect of PDI's core benefit in a preferred embodiment of the invention and how it's unique structure provides value to the customer. The insured has a $10,000 PDI policy and lives in Oklahoma. A tornado strikes the area, including the insured's home and damages the home's roof. Damage amounts to $15,000, the insured's home insurance policy only pays $5,000 of the total $15,000 in damage because the roof is 10 years old and only had a useful life of 15 years (⅓ remaining). PDI pays the insured the full policy amount of $10,000 which offset's the gap from the home insurance.

The following prophetic example further illustrates how one of the preferred endorsements would operate in the event of a natural disaster. The insureds live in North Carolina and purchased a Personal Disaster Insurance policy (stand-alone) from an insurance carrier, and elected endorsements which included the emergency supply kit endorsement. A category 4 hurricane causes massive damage to the area. Power is lost by the insureds for 48 hours which triggers the insureds receipt of an emergency supply kit from the Power Loss Endorsement they purchased irrespective of any claim rights the insureds have against their homeowner's coverage. The Insured follows the claims procedures to document the power outage and completes the online claim affidavit using his Smartphone or iphone and e-sign the document and request delivery of the supply kit at their home of record. The carrier receives their claim submission in real time and begins immediate adjudication. The carrier confirms the insured's home of record is in a disaster declaration area and confirms with the power company that the power has been out and is out in the insured's area. The carrier affirms the claims affidavit is complete and has a delivery address for the emergency supply kit. The claims resource inputs the elected supply kit option elected by the insured into the supplier's order mechanism (supplier has designated a carrier specific web address for the carrier to process disaster requests). The supplier has service level agreements (SLA) in place that require rapid processing, preferably in no more than 4 hours. The supplier ships the kit within the required SLA. The freight service (e.g. FedEx, UPS, or USPS) delivers the kit to the required location.

A general purpose computing system connected to a general purpose electronic network, such as a computer network, is utilized. In one embodiment the computer network can be a virtual private network or a public network, such as the Internet. The computer system includes a central processing unit (CPU) connected to a system memory. The system memory typically contains an operating system, a BIOS driver, and application programs. In addition, the computer system contains input devices such as a mouse or a keyboard, and output devices such as a printer and a display monitor, and a permanent data store, such as a database. The computer system generally includes a communications interface to communicate to the electronic network. Other computer systems also connect to the electronic network which can be implemented as a Wide Area Network (WAN) or as an internetwork, such as the Internet. Data is stored either in many local repositories and synchronized with a central warehouse optimized for queries and for reporting, or is stored centrally in a dual use database. This system is one example of a system that could execute the method steps set forth above.

The foregoing description of preferred embodiments of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

1. A computer-implemented method for processing data related to the provision of personal disaster insurance policies covering property in different geographic areas to policy owners, said method comprising:
storing in a data storage device data associated with said personal disaster insurance wherein said data includes information about the personal disaster insurance policies sold covering property in low risk geographic areas, medium risk geographic areas, and high risk geographic areas;
using a computer to perform a risk tolerance determination by determining whether the policies sold covering property in the low risk geographic areas, the medium risk geographic areas, and the high risk geographic areas are within a predetermined risk tolerance; and
discontinuing the sale of new policies covering property in high risk geographic areas when the policies already sold covering property in the low risk geographic areas, the medium risk geographic areas, and the high risk geographic areas are outside of the predetermined risk tolerance.

2. The method of claim 1 further comprising the step of discontinuing the sale of new policies covering property in medium risk geographic areas when the policies already sold covering property in the low risk geographic areas, the medium risk geographic areas, and the high risk geographic areas are outside of the predetermined risk tolerance.

3. The method of claim 1 further comprising electronically sending instructions to an enrollment engine allowing for continued acceptance and processing of new policy applications in the high risk geographic area when the policies already sold covering property in the low risk geographic areas, the medium risk geographic areas, and the high risk geographic areas are within the predetermined risk tolerance.

4. The method of claim 1 wherein the data maintained by the data storage device includes geographical data providing location about all property insured in the low risk geographic areas, the medium risk geographic areas, and the high risk geographic areas.

5. The method of claim 1 wherein the data maintained by the data storage device includes information about an obligation amount of personal disaster insurance coverage in each of the policies sold covering property in the low risk geographic areas, the medium risk geographic areas, and the high risk geographic areas.

6. The method of claim 1 wherein the data maintained in the data storage device includes a total obligation amount of all policies sold covering property in the low risk geographic areas, the medium risk geographic areas, and the high risk geographic areas.

7. The method of claim 6 further comprising using the data maintained in the data storage device to create a risk profile based on the total obligation amount.

8. The method of claim 1 further comprising generating a report of the the policies sold covering property in the low risk geographic areas, the medium risk geographic areas, and the high risk geographic areas.

9. The method if claim 1 wherein the determination of whether the policies sold covering property in the low risk geographic areas, the medium risk geographic areas, and the high risk geographic areas are within a predetermined risk tolerance is performed continuously.

10. The method of claim 1 wherein the determination of whether the policies sold covering property in the low risk geographic areas, the medium risk geographic areas, and the high risk geographic areas are within a predetermined risk tolerance is performed periodically.

11. The method of claim 6 wherein the risk tolerance determination includes predetermined thresholds.

12. The method of claim 11 wherein the predetermined thresholds are based upon total obligation amount.

13. The method of claim 11 wherein the predetermined thresholds are based upon the number of properties insured in each of the low risk geographic areas, the medium risk geographic areas, and the high risk geographic areas.

14. The method of claim 11 wherein the predetermined thresholds are based upon risk ratios created from the total obligation amount and the number of properties insured in each of the low risk geographic areas, the medium risk geographic areas, and the high risk geographic areas.

15. The method of claim 1 further comprising sending instructions to personnel engaged in the sales and processing of personal disaster insurance policies allowing for continued acceptance and processing of new policy applications based upon an automatic determination that the predetermined risk tolerance is not exceeded.

16. The method of claim 1 further comprising sending instructions to personnel engaged in the sales and processing of personal disaster insurance policies discontinuing the acceptance of new policy applications based upon an automatic determination that the predetermined risk tolerance is exceeded.

17. The method of claim 16 whereby the automatic instructions restrict the sales of new policy applications for insurance coverage in excess of a predetermined amount within specific risk areas.

18. The method of claim 1 further comprising the step of notifying new policy applicants of the discontinuance of writing new policies.

19. The method of claim 16 further comprising the step of removing the restriction as to new business sales based upon the automatic analysis of current business whereby the predetermined risk tolerance is no longer exceeded.

20. The method of claim 19 further comprising the step of notifying new policy applicants when the discontinuance of writing new business has been removed.

21. A computer-implemented method for processing data related to the provision of personal disaster insurance policies covering property in different geographic areas to policy owners, said method comprising:
storing in a data storage device data associated with said personal disaster insurance wherein said data includes information about the personal disaster insurance policies sold covering property in low risk geographic areas, medium risk geographic areas, and high risk geographic areas;
using a computer to perform a risk tolerance determination by determining whether the policies sold covering property in the low risk geographic areas, the medium risk geographic areas, and the high risk geographic areas are within a predetermined risk tolerance; and
discontinuing the sale of new policies covering property in high risk geographic areas and medium risk geographic areas when the policies already sold covering property in the low risk geographic areas, the medium risk geographic areas, and the high risk geographic areas are outside of the predetermined risk tolerance.

22. A computer-implemented method for processing data related to the provision of personal disaster insurance policies covering property in different geographic areas to policy owners, said method comprising:
storing in a data storage device data associated with said personal disaster insurance wherein said data includes information about the personal disaster insurance policies sold covering property in low risk geographic areas, medium risk geographic areas, and high risk geographic areas;
using a computer to perform a risk tolerance determination by determining whether the policies sold covering property in the low risk geographic areas, the medium risk geographic areas, and the high risk geographic areas are within a predetermined risk tolerance;
discontinuing the sale of new policies covering property in high risk geographic areas and medium risk geographic areas when the policies already sold covering property in the low risk geographic areas, the medium risk geographic areas, and the high risk geographic areas are outside of the predetermined risk tolerance; and
reinstating the sale of new policies covering property in high risk geographic areas and medium risk geographic areas when the policies already sold covering property in the low risk geographic areas, the medium risk geographic areas, and the high risk geographic areas are within the predetermined risk tolerance.
